(19) United States
(12) Patent Application Publication
(10) Pub. No.: US 2023/0068479 A1
(43) Pub. Date: Mar. 2, 2023

(54) CATHODE COMPOSITE MATERIAL FOR LITHIUM-ION BATTERY (LIB), AND PREPARATION METHOD THEREOF

(71) Applicant: BASF Shanshan Battery Materials Co., Ltd., Changsha (CN)

(72) Inventors: Hong DONG, Changsha (CN); Xiangkang JIANG, Changsha (CN); Hui SHI, Changsha (CN); Mengqing WANG, Changsha (CN); Xiaofei BIE, Changsha (CN); Bo LI, Changsha (CN); Jin HU, Changsha (CN)

(73) Assignee: BASF Shanshan Battery Materials Co., Ltd., Changsha (CN)

(21) Appl. No.: 17/723,727

(22) PCT Filed: Oct. 21, 2020
(86) PCT No.: PCT/CN2020/122366

§ 371 Date: Oct. 10, 2022

(30) Foreign Application Priority Data
Nov. 6, 2019 (CN) 201911075039.9

(51) Int. Cl. H01M 4/36; H01M 4/58; H01M 10/0525; C01G 51/00

(52) U.S. Cl. CPC H01M 4/366; H01M 4/5825; H01M 10/0525; C01G 51/42; H01M 2004/028

(57) ABSTRACT

The present disclosure discloses a cathode composite material for a lithium-ion battery (LIB), and a preparation method thereof. The cathode composite material for an LIB is composed of a lithium-containing matrix and a three-layer coating layer coated on a surface of the matrix, where the three-layer coating layer includes a lithium-deficient matrix material layer, a lithium-deficient lithium cobalt phosphate (LCP) layer, and a cobalt phosphate layer in sequence from inside to outside. The cathode composite material of the present disclosure can reduce the oxidation of a highly-delithiated cathode material to an electrolyte under high voltage, and has a high energy density.

### CROSS-REFERENCE TO RELATED APPLICATIONS

The application claims priority to Chinese patent application No. 201911075039.9, filed on Nov. 6, 2019, the entire contents of which are incorporated herein by reference.

### TECHNICAL FIELD

The present disclosure belongs to the technical field of lithium-ion batteries (LIBs), and in particular relates to a cathode composite material for an LIB, and a preparation method thereof.

### BACKGROUND ART

With the continuous prosperity of the power battery field, market requirements for the energy density of LIBs are increasing. In order to improve the energy density, researchers continue to improve the cut-off voltage of LIB cathode materials. Although a highly-delithiated cathode material shows a prominent energy density at a high voltage, the highly-delithiated cathode material also has strong oxidizing properties and is easy to undergo a side reaction with an organic electrolyte, resulting in the reduction of battery performance, cycling life, and safety. The prior art shows that the modification of a cathode material by surface coating is one of the important means to reduce the disadvantages under high voltage conditions; and the use of lithium cobalt oxide (LCO) or other cathode materials to coat a surface of Co₃(PO₄)₂ can improve the cycling performance and high-temperature storage performance of the cathode material.

In the prior art, methods of coating a cathode material with cobalt phosphate mainly include: (1) A cathode material is added to a soluble cobalt salt solution, then a soluble phosphate solution is added, and a resulting mixture is thoroughly mixed and then subjected to a heat treatment. (2) A soluble cobalt salt is mixed with a phosphate solution, then a cathode material is added, and a resulting mixture is thoroughly mixed and then subjected to a heat treatment. (3) A soluble cobalt salt solution is mixed with a soluble phosphate solution to obtain micron-sized large particles, then the particles are mixed with a cathode material, and a resulting mixture is subjected to a heat treatment. In the above several preparation methods, since the soluble cobalt salt and phosphate will quickly produce micron-sized large particles after being mixed, the cobalt phosphate cannot be thoroughly mixed with a matrix material, and thus the cobalt phosphate cannot be uniformly coated on a cathode material matrix during a heat treatment process. In addition, the above preparation methods all adopt liquid phase coating, and a solvent used in the liquid phase coating will erode a surface of a cathode material, which results in damage to a surface structure of the cathode material and easily causes excessive initial capacity loss.

### SUMMARY

A technical problem to be solved by the present disclosure: A cathode material for an LIB and a preparation method thereof are provided to overcome the deficiencies and shortcomings mentioned in the above background art.

In order to solve the above technical problem, the present disclosure provides the following technical solutions.

A cathode composite material for an LIB is provided, including a lithium-containing matrix and a three-layer coating layer coated on a surface of the matrix, where the three-layer coating layer includes a lithium-deficient matrix material layer, a lithium-deficient lithium cobalt phosphate (LCP) layer, and a cobalt phosphate layer in sequence from inside to outside.

A design idea of the above technical solution is as follows: A surface of a cathode material matrix is covered with a lithium-deficient matrix material layer, a lithium-deficient LCP layer, and a cobalt phosphate layer in sequence from inside to outside, where the outer layer is a coating layer without high-valent cobalt, which reduces the oxidation of tetravalent cobalt in the highly-delithiated cathode material on an electrolyte under high voltage and thus avoids the formation of an inert film at an interface between the material and the electrolyte to deteriorate an interface environment and reduce the performance of the cathode material; and the three coating layers on the above cathode composite material are all composed of a high-voltage material, such that a discharge voltage during a charging and discharging process can be higher than that of the uncoated cathode material, and a battery fabricated therefrom will have a higher energy density.

As a preference of the above technical solution, the lithium-containing matrix may be a layered lithium composite oxide, with a chemical formula of LiₐCo_{1-b}M_{b}O₂, where M is one or more selected from the group consisting of Mg, Al, Ti, Zr, and W, 0.95≤a≤1.1, and 0.0≤b≤0.01. The selection of layered lithium composite oxide as the matrix can ensure that, after lithium-deficient LCP is formed from cobalt phosphate, the matrix further reacts with the lithium-deficient LCP to form an inner lithium-deficient matrix material layer, which enables the easy formation of the three-layer coating layer structure and is beneficial for the stability of the overall structure.

As a preference of the above technical solution, the lithium-deficient matrix material layer may have a chemical formula of Li_{c}Co_{1-b}M_{b}O₂, where M is one or more selected from the group consisting of Mg, Al, Ti, Zr. and W, 0.0<c<1.0, and 0.0≤b≤0.01.

As a preference of the above technical solution, the lithium-deficient LCP layer may have a chemical formula of Li_{d}CoPO₄, where 0.0<d<1.0.

As a preference of the above technical solution, the cobalt phosphate layer may have a chemical formula of Coₘ(PO₄)ₙ, where m/n=1.3 to 1.7. An idea of the design hem is as follows: After the cobalt phosphate layer with the chemical formula of Coₘ(PO₄)ₙ is adopted, there will be no tetravalent Co after dilithiation, which avoids the contact between tetravalent cobalt and an electrolyte; and a potential is higher than that of LCO, which helps to improve the discharge voltage.

As a preference of the above technical solution, the lithium-deficient LCP layer may have a thickness of no more than 10 nm, and the cobalt phosphate layer may have a thickness of no more than 10 nm.

As a preference of the above technical solution, the cathode composite material may have a D50 particle size of 6 μm to 23 μm.

A preparation method of the cathode composite material described in anyone of the above technical solutions is provided, including the following steps:

(1) mixing a cathode material precursor and a lithium source, and subjecting a resulting mixture to a heat treatment for 6 h to 20 h to obtain the lithium-containing matrix with a chemical formula of LiₐCo_{1-b}M_{b}O₂; and

(2) mixing cobalt phosphate and the lithium-containing matrix, and subjecting a resulting mixture to a heat treatment for 3 h to 9 h to obtain the cathode composite material, where a mass ratio of the cobalt phosphate to the cathode material matrix is (0.005:1) to (0.5:1).

A design idea of the above technical solution is as follows: The cobalt phosphate and lithium-containing matrix are mixed to make the cobalt phosphate uniformly adsorbed on a surface of the lithium-containing matrix; and after the heat treatment, part of the cobalt phosphate exists in the outermost layer in the form of anhydrous cobalt phosphate, part of the cobalt phosphate reacts with the residual LiOH, Li₂CO₃, or LiHCO₃ on a surface of the lithium-containing matrix to obtain lithium-deficient LCP, and the lithium-deficient LCP further reacts with the cathode material matrix to obtain a matrix material layer with some lithium ions removed, thereby forming the three-layer coating structure on the surface of the cathode material.

As a preference of the above technical solution, in step (1), the heat treatment may be conducted at 900° C. to 1.100° C. for 6 h to 20 h.

As a preference of the above technical solution, in step (2), the heat treatment may be conducted at 400° C. to 900° C.

As a preference of the above technical solution, in step (2), when the mass ratio of the cobalt phosphate to the cathode material matrix is (0.005:1) to (0.02:1), the heat treatment may be conducted at 400° C. to 600° C. for 3 h to 6 h; when the mass ratio of the cobalt phosphate to the cathode material matrix is (0.02:1) to (0.04:1), the heat treatment may be conducted at 600° C. to 800° C. for 5 h to 9 h; and when the mass ratio of the cobalt phosphate to the cathode material matrix is (0.04:1) to (0.05:1), the heat treatment may be conducted at 800° C. to 900° C. for 7 h to 9 h. An idea of this design is as follows: Temperature and time ranges of the heat treatment are determined according to a mass ratio of the cobalt phosphate to the matrix, and then the mixture is subjected to the heat treatment accordingly to obtain the cathode composite material. In order to ensure the formation of a three-layer coating layer with a specified thickness to make the material have prominent electrochemical performance, the phosphate and the matrix need to be subjected to an adequate reaction under specified conditions. The increase in the temperature and time of the heat treatment will increase a degree of the reaction between the cobalt phosphate and the residual lithium compound on the surface of the matrix and a degree of the reaction between the lithium-deficient LCP and the matrix, thereby adjusting corresponding thicknesses of the three layers. Therefore, in order to obtain a cathode material with a third coating layer of a small thickness, when an amount of cobalt phosphate added is high, a high heat treatment temperature and a long heat treatment time are designed. Moreover, by further defining a positive correlation relationship between the temperature and time of the heat treatment and the mass ratio of the cobalt phosphate to the cathode material matrix, the degree of reaction between the cobalt phosphate and the residual lithium compound on the surface of the matrix and the degree of reaction between the lithium-deficient LCP and the matrix can be controlled accurately to obtain a cathode composite material with a three-layer coating layer thickness that meets the expected design, such that the cathode composite material shows stability to an electrolyte under high voltage, and the specific capacity will not decrease due to a too-high thickness of the coating layer.

As a preference of the above technical solution, the cobalt phosphate may have a chemical formula of Coₘ(PO₄)ₙ.XH₂O, where m/n=1.3 to 1.7 and X=0 to 12.

As a preference of the above technical solution, the cobalt phosphate may have a particle size of 5 nm to 200 nm. Purpose of this design: By selecting nano-scale cobalt phosphate as a coating raw material, the probability that cobalt phosphate is adsorbed on the surface of the cathode material matrix in the form of blocks during mixing is reduced, such that the cobalt phosphate is distributed uniformly, and a coating layer with the same structure, uniform thickness, and uniform distribution can be formed after the heat treatment.

Compared with the prior art, the present disclosure has the following advantages:

(1) The cathode composite material of the present disclosure is covered with an outer coating layer without high-valent cobalt, which reduces the oxidation of the highly-delithiated cathode material on an electrolyte under high voltage; and the three coating layers are all composed of a high-voltage material, such that a discharge voltage during a charging and discharging process can be higher than that of the uncoated cathode material, and an energy density is higher.

(2) In the preparation method of the cathode composite material of the present disclosure, a dry method and a heat treatment are used to coat the cathode material, which avoids the possible erosion of liquid-phase coating under the same effect to the surface of the cathode material and the reduction of electrochemical performance caused thereby, and leads to a coating layer with uniform thickness and stable properties.

### BRIEF DESCRIPTION OF THE DRAWINGS

To describe the technical solutions in examples of the present disclosure or in the prior art more clearly, the accompanying drawings required for describing the examples or the prior art will be briefly described below. Apparently, the accompanying drawings in the following description show some examples of the present disclosure, and a person of ordinary skill in the art may still derive other drawings from these accompanying drawings without creative efforts.

FIG. 1 is a transmission electron microscopy (TEM) image of nano-cobalt phosphate;

FIG. 2 is a TEM image of a mixture of nano-cobalt phosphate and a matrix;

FIG. 3 is a TEM image of a mixture of nano-cobalt phosphate and a matrix after a heat treatment;

FIG. 4 shows X-ray diffractometry (XRD) patterns before and after the heat treatment of nano-cobalt phosphate;

FIG. 5 is a TEM image of a cross section of a cathode composite material;

FIG. 6a is an X-ray photoelectron spectroscopy (XPS) spectrum of Li and FIG. 6b is an XPS test spectrum of P;

FIG. 7 is a schematic diagram illustrating situations of a mixture of cobalt phosphate and a cathode material before and after a heat treatment:

FIG. 8 is a charge-discharge curve diagram of the cathode composite material of Example 1;

FIG. 9 shows the cycling performance of the cathode materials of Example 5 and Comparative Example 1:

FIG. 10 shows average discharge voltages of the cathode composite material of Example 2 after different cycles; and

FIG. 11 shows an electron microscopy image of the cathode composite material of Example 5 and an electron microscopy image of the cathode composite material prepared by the conventional method in Comparative Example 2.

### DETAILED DESCRIPTION

In order to facilitate the understanding of the present disclosure, the present disclosure is described in detail below in conjunction with the accompanying drawings of the specification and the preferred examples, but the protection scope of the present disclosure is not limited to the following specific examples.

Unless otherwise defined, all technical terms used hereinafter have the same meaning as commonly understood by those skilled in the art. The technical terms used herein are merely for the purpose of describing specific examples, and are not intended to limit the protection scope of the present disclosure.

Unless otherwise specified, various raw materials, reagents, instruments, equipment, and the like used in the present disclosure can be purchased from the market or can be prepared by existing methods.

### EXAMPLE 1

A cathode composite material for an LIB is provided, which has a D50 particle size of 10 μm to 11 μm and is composed of a layered lithium composite oxide matrix with a chemical formula of Li_{1.01}Co_{0.995}Al_{0.003}Mg_{0.002}O₂ and a three-layer coating layer on a surface of the matrix. The three-layer coating layer is composed of a lithium-deficient matrix material layer, a lithium-deficient LCP layer, and a cobalt phosphate layer with a chemical formula of Co₃(PO₄)₂. The cobalt phosphate layer has a thickness of 3 nm to 5 nm, and the lithium-deficient LCP layer has a thickness of 4 nm to 9 nm.

A preparation method of the cathode composite material is provided, including the following steps:

(1) cobalt oxide, lithium carbonate, aluminum oxide, and magnesium oxide were thoroughly mixed, subjected to a high-temperature heat treatment at 950° C. for 10 h, and crushed to obtain an LCO matrix with D50 of 10 μm, which had a chemical formula of Li_{1.01}Co_{0.995}Al_{0.003}Mg_{0.002}O₂; and

(2) 1 Kg of the LCO matrix prepared in step (1) and 10 g of nano-cobalt phosphate Co₃(PO₄)₂.8H₂O were thoroughly mixed through ball-milling, and then subjected to a heat treatment at 550° C. for 4 h to obtain the cathode composite material. The cathode composite material is numbered as LCO-A1, and the untreated LCO matrix is numbered as LCO-A0 (that is, the matrix material prepared in step (1)).

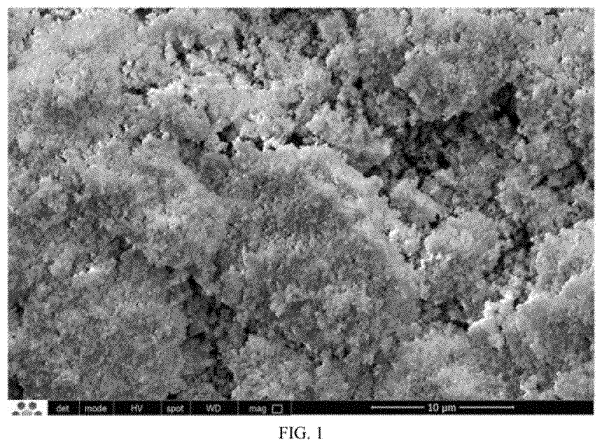

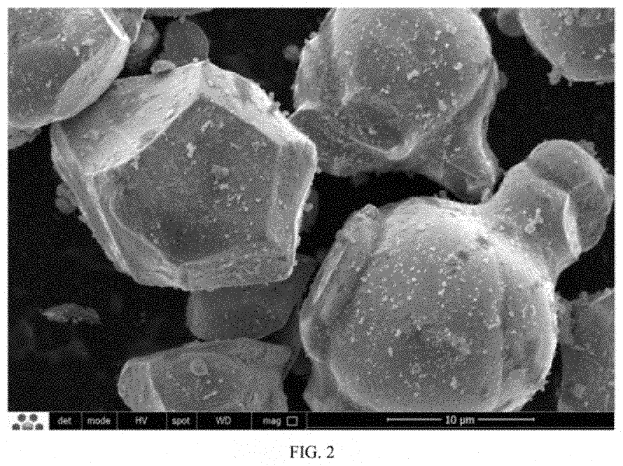

The morphology of the added nano-cobalt phosphate is shown in FIG. 1, and it can be clearly seen that particles of cobalt phosphate are nano-agglomerated. The morphology of the mixture of the nano-cobalt phosphate and the LCO matrix (before the heat treatment) is shown in the FIG. 2, and it can be clearly seen that the nano-cobalt phosphate is relatively uniformly adsorbed to a surface of the matrix, showing very uniform distribution.

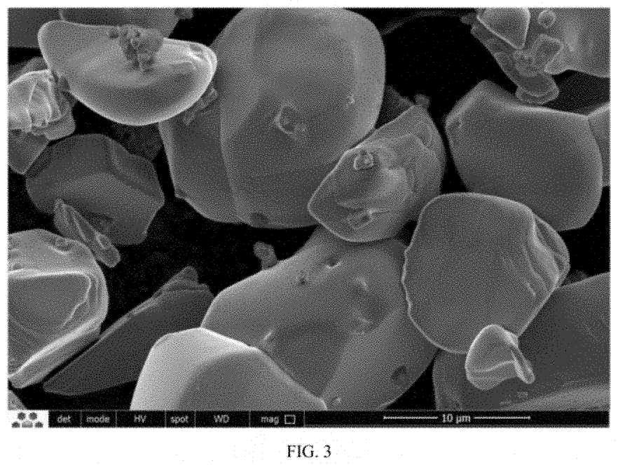

The morphology of the mixture of the nano-cobalt phosphate and the LCO matrix after the heat treatment is shown in FIG. 3, and it can be seen that the surface of the matrix is uniformly coated, the formed cathode composite material has a smooth surface, and the coating layer is uniform.

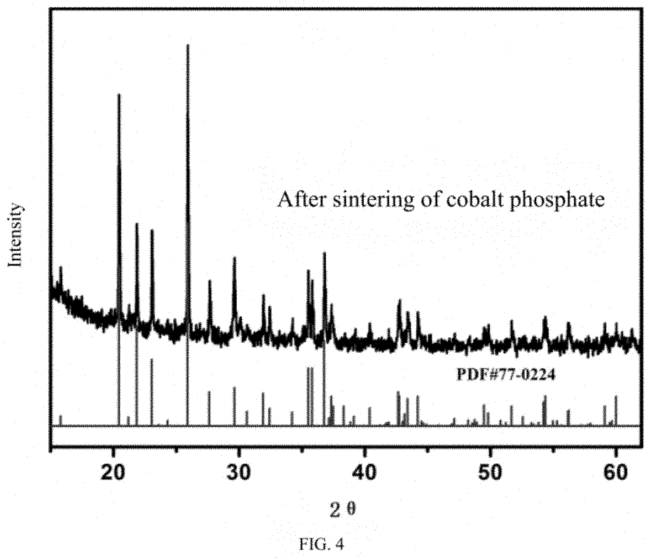

An XRD pattern of the nano-cobalt phosphate after the heat treatment is shown in FIG. 4, and it can be seen that the structure of the nano-cobalt phosphate does not change greatly after the heat treatment.

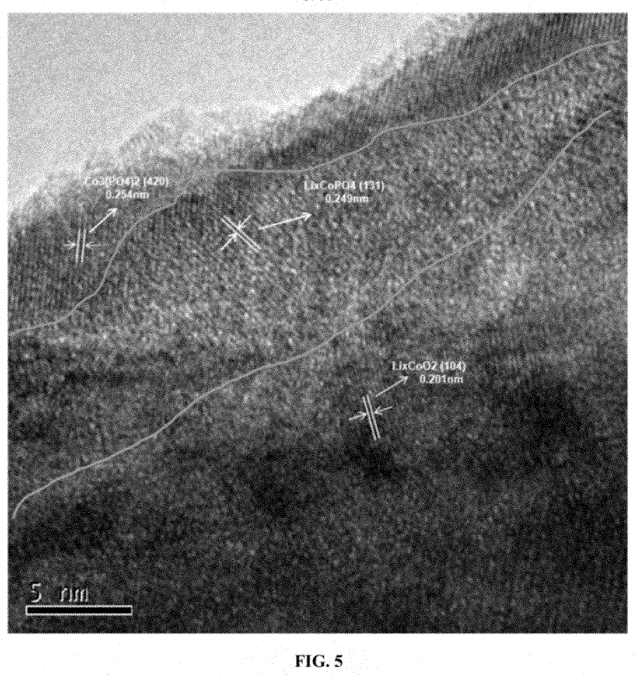

Across-sectional TEM image of the cathode composite material formed after the mixture of the nano-cobalt phosphate and the LCO matrix is subjected to the heat treatment is shown in FIG. 5, and it can be clearly seen that there are obvious three layer structures with different lattice fringes at different distances from the material surface.

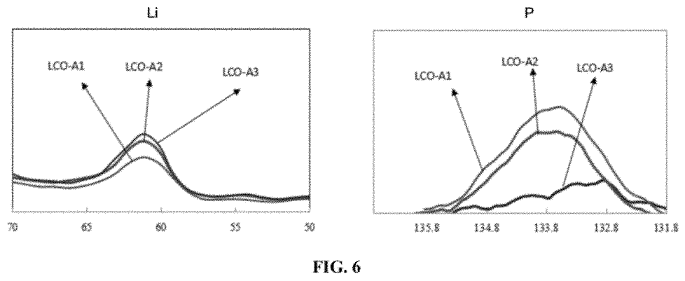

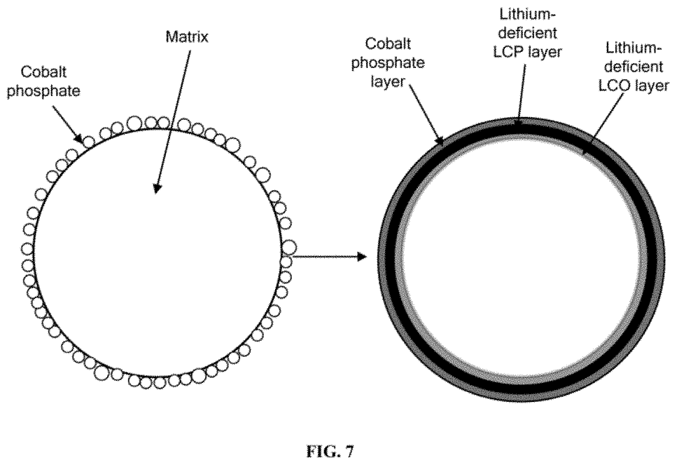

In order to indirectly determine element distributions at different distances from the surface, the cathode composite material prepared in this example was subjected to an acid attack treatment, and XPS was used to test element contents at different depths. Specific steps: a dilute hydrochloric acid solution with a concentration of 0.1 mol/L was prepared; 10 g of LCO-A1 was immersed in the solution for 1 min, washed with deionized water, and then dried in an oven at 80° C., and a resulting product was numbered as LCO-A2; and 10 g of LCO-AI was immersed in the solution for 3 min, washed with deionized water, and then dried in an oven at 80° C., and a resulting product was numbered as LCO-A3. The LCO-A1, LCO-A2, and LCO-A3 each were subjected to an XPS test. Test results are shown in FIG. 6. It can be seen from FIG. 6a that the Li content gradually increases from outside to inside, and it can be seen from FIG. 6b that the phosphorus content gradually decreases from outside to inside, which corresponds to the three-layer coating layer structure model and TEM test results of the cathode composite material. A schematic diagram illustrating situations of the mixture of the cobalt phosphate and the cathode material before and after the heat treatment is shown in FIG. 7.

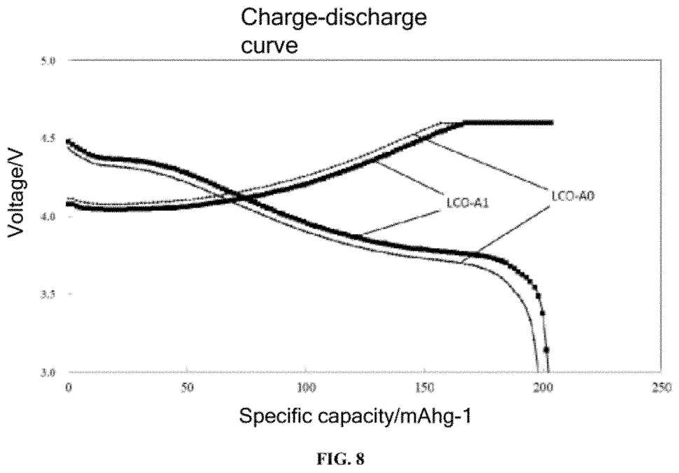

The LCO-A0 and LCO-A1 were subjected to a charge-discharge test. Charge-discharge curves are shown in FIG. 8, and it can be seen from the figure that the electrochemical polarization degree of the coated cathode composite material is significantly reduced during the charge-discharge process.

### EXAMPLE 2

A cathode composite material for an LIB is provided, which has a D50 particle size of 19 μm to 20 μm and is composed of a layered lithium composite oxide matrix with a chemical formula of Li_{1.01}Co_{0.996}Al_{0.002}Ti_{0.001}Mn_{0.001}O₂ and a three-layer coating layer on a surface of the matrix. The three-layer coating layer is composed of a lithium-deficient matrix material layer, a lithium-deficient LCP layer, and a cobalt phosphate layer with a chemical formula of Co_{3.5}(PO₄)₂. The cobalt phosphate layer has a thickness of 3 nm to 5 nm, and the lithium-deficient LCP layer has a thickness of 3 nm to 6 nm.

A preparation method of the cathode composite material is provided, including the following steps:

(1) cobalt oxide, lithium carbonate, aluminum oxide, titanium oxide, and manganese oxide were thoroughly mixed, subjected to a high-temperature heat treatment at 1,000° C. for 10 h, and crushed to obtain an LCO matrix with D50 of 19 μm, which had a chemical formula of Li_{1.01}Co_{0.996}Al_{0.002}Ti_{0.001}Mn_{0.001}O₂; and

(2) 1 Kg of the LCO matrix prepared in the above step and 30 g of nano-cobalt phosphate Co_{3.5}(PO₄)₂.8H₂O were thoroughly mixed through ball-milling, and then subjected to a heat treatment at 600° C. for 5 h to obtain the cathode composite material. The cathode composite material is numbered as LCO-C1, and the untreated LCO matrix is numbered as LCO-C0 (that is, the matrix material prepared in step (1)).

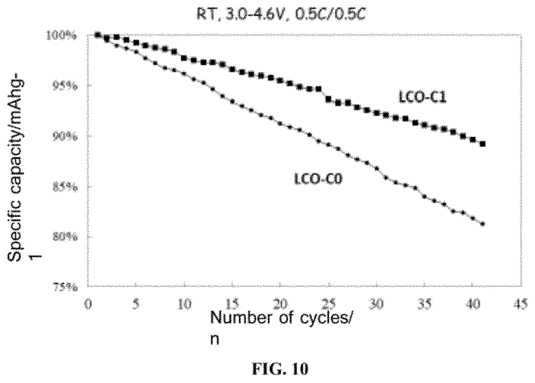

The LCO-C0 and LCO-C1 were subjected to a continuous discharge test, and average discharge voltages after different cycles were recorded. Results are shown in FIG. 10, and it can be seen from the figure that the average discharge voltage of the cathode composite material in this example after multiple cycles is significantly higher than that of the uncoated cathode material, which proves that the cycling stability of the cathode composite material of this example is better than that of the uncoated cathode material.

### EXAMPLE 3

A cathode composite material for an LIB is provided, which has a D50 particle size of 21 μm to 22 μm and is composed of a layered lithium composite oxide matrix with a chemical formula of Li_{1.015}Co_{0.995}Ti_{0.001}Ca_{0.002}Mn_{0.002}O₂ and a three-layer coating layer on a surface of the matrix. The three-layer coating layer is composed of a lithium-deficient matrix material layer, a lithium-deficient LCP layer, and a cobalt phosphate layer with a chemical formula of Co_{2.8}(PO₄)₂. The cobalt phosphate layer has a thickness of 4 nm to 6 nm, and the lithium-deficient LCP layer has a thickness of 6 nm to 10 nm.

A preparation method of the cathode composite material is provided, including the following steps:

(1) cobalt oxide, lithium carbonate, calcium oxide, titanium oxide, and manganese oxide were thoroughly mixed, subjected to a high-temperature heat treatment at 1.100° C. for 12 h, and crushed to obtain an LCO matrix with D50 of 21 μm, which had a chemical formula of Li_{1.015}Co_{0.995}Ti_{0.001}Ca_{0.002}Mn_{0.002}O₂; and

(2) 1 Kg of the LCO matrix prepared in the above step and 50 g of nano-cobalt phosphate Co_{2.8}(PO₄)2.8H₂O were thoroughly mixed through ball-milling, and then subjected to a heat treatment at 850° C. for 8 h to obtain the cathode composite material. The cathode composite material is numbered as LCO-D1, and the untreated LCO matrix is numbered as LCO-D0 (that is, the matrix material prepared in step (1)).

Square aluminum-shell batteries fabricated by LCO-D0 and LCO-D1 were tested for high-temperature storage performance. Results are shown in Table 1, and it can be seen from the test results that a thickness increase of a battery fabricated by the cathode composite material with the three-layer coating layer structure in this example under high temperature is significantly lower than that of a battery fabricated by the uncoated cathode material under the same conditions, indicating that the cathode composite material of this example has better high-temperature stability.

TABLE 1
High-temperature storage performance
of square aluminum-shell batteries

| | LCO-D0 | LCO-D1 |
|---|---|---|
| Battery thickness increase after 6 h at 85° C. (%) | 17.7 | 9.8 |
| Battery thickness increase after 7 d at 60° C. (%) | 45.2 | 26 |

### EXAMPLE 4

A cathode composite material for an LIB is provided, which has a D50 particle size of 20 μm to 21 μm and is composed of a layered lithium composite oxide matrix with a chemical formula of Li_{1.01}Co_{0.996}Al_{0.002}Ti_{0.002}O₂ and a three-layer coating layer on a surface of the matrix. The three-layer coating layer is composed of a lithium-deficient matrix material layer, a lithium-deficient LCP layer, and a cobalt phosphate layer with a chemical formula of Co₃(PO₄)₂. The cobalt phosphate layer has a thickness of 5 nm to 9 nm, and the lithium-deficient LCP layer has a thickness of 6 nm to 10 nm.

A preparation method of the cathode composite material is provided, including the following steps:

(1) cobalt oxide, lithium carbonate, aluminum oxide, and titanium oxide were thoroughly mixed, subjected to a heat treatment at 1,000° C. for 12 h, and crushed to obtain an LCO matrix with D50 of 20 μm, which had a chemical formula of Li_{1.01}Co_{0.996}Al_{0.002}Ti_{0.002}O₂; and

(2) 1 Kg of the LCO matrix prepared in the above step and 20 g of nano-cobalt phosphate Co₃(PO₄)₂.8H₂O were thoroughly mixed through ball-milling, and then subjected to a heat treatment at 500° C. for 6 h to obtain the cathode composite material. The cathode composite material is numbered as LCO-B1, and the untreated LCO matrix is numbered as LCO-B0 (that is, the matrix material prepared in step (1)).

### EXAMPLE 5

A cathode composite material for an LIB is provided, which has a D50 particle size of 20 μm to 21 μm and is composed of a layered lithium composite ox ide matrix with a chemical formula of Li_{1.005}Co_{0.995}Al_{0.003}Mg_{0.001}Ti_{0.002}O₂ and a three-layer coating layer on a surface of the matrix. The three-layer coating layer is composed of a lithium-deficient matrix material layer, a lithium-deficient LCP layer, and a cobalt phosphate layer with a chemical formula of Co₃(PO₄)₂. The cobalt phosphate layer has a thickness of 2 nm to 6 nm, and the lithium-deficient LCP layer has a thickness of 5 nm to 9 nm.

A preparation method of the cathode composite material is provided, including the following steps:

(1) cobalt oxide, lithium carbonate, aluminum oxide, and magnesium oxide were thoroughly mixed, subjected to a heat treatment at 1,010° C. for 12 h, and crushed to obtain an LCO matrix with D50 of 20 μm, which had a chemical formula of Li_{1.005}Co_{0.995}Al_{0.003}Mg_{0.001}Ti_{0.002}O₂; and

(2) 1 Kg of the LCO matrix prepared in the above step and 11 g of nano-cobalt phosphate Co₃(PO₄)₂.8M₂O were thoroughly mixed through ball-milling, and then subjected to a heat treatment at 500° C. for 5 h to obtain the cathode composite material. The cathode composite material is numbered as LCO-F1.

### COMPARATIVE EXAMPLE 1

A preparation method of a cathode composite material includes the following steps:

(1) cobalt oxide, lithium carbonate, aluminum oxide, and titanium oxide were thoroughly mixed, subjected to a heat treatment at 1,000° C. for 12 h, and crushed to obtain an LCO matrix with D50 of 20 μm, which had a chemical formula of Li_{1.01}Co_{0.996}Al_{0.002}Ti_{0.002}O₂; and

(2) 1 Kg of the LCO matrix prepared in the above step and 20 g of purchased cobalt phosphate (microscale) Co₃(PO₄)2.8H₂O were thoroughly mixed through ball-milling, and then subjected to a heat treatment at 500° C. for 6 h to obtain the cathode composite material, numbered as LCO-B2.

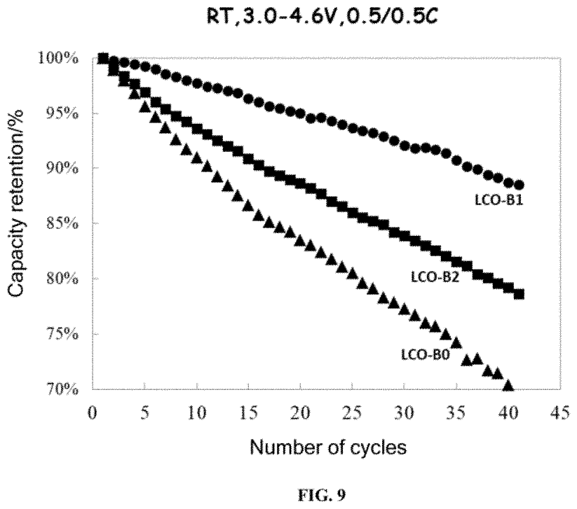

The initial discharge capacity and cycling performance were tested for LCO-B0, LCO-B1, and LCO-B2. Results are shown in Table 2 and FIG. 9, and it can be seen from Table 2 and FIG. 9 that the cathode composite material prepared by coating the cathode material with the purchased micro-cobalt phosphate has a large capacity loss when used for the first time, and shows cycling stability that is improved to some extent compared with that of the uncoated cathode material; and in contrast, the cathode composite material prepared by coating the cathode material with nano-cobalt phosphate (namely, the cathode composite material of Example 4) has no capacity loss when used for the first time under the same conditions, and shows cycling performance that is improved significantly.

TABLE 2
Test results of the initial discharge capacity

| | LCO-B0 | LCO-B1 | LCO-B2 |
|---|---|---|---|
| Initial capacity (mAhg⁻¹) | 211.2 | 211.0 | 209.9 |

### COMPARATIVE EXAMPLE 2

A preparation method of the cathode composite material is provided, including the following steps:

(1) 11.9 g of cobalt chloride hexahydrate was dissolved in 1 L of deionized water to obtain a solution A, 5.2 g of sodium dihydrogen phosphate dihydrate was dissolved in 1 L of deionized water to obtain a solution B, and the solution A and the solution B were mixed; a final pH of a mixed solution was controlled to 7, 1 Kg of an LCO matrix was added, and a resulting mixture was thoroughly stirred; and the LCO matrix was dried at 80° C. to obtain cobalt phosphate-coated LCO. An amount of phosphate coated by the wet method is the same as that in Example 5; and

(2) the coated LCO was subjected to a heat treatment at 500° C. for 5 h to obtain a product, numbered as LCO-F2.

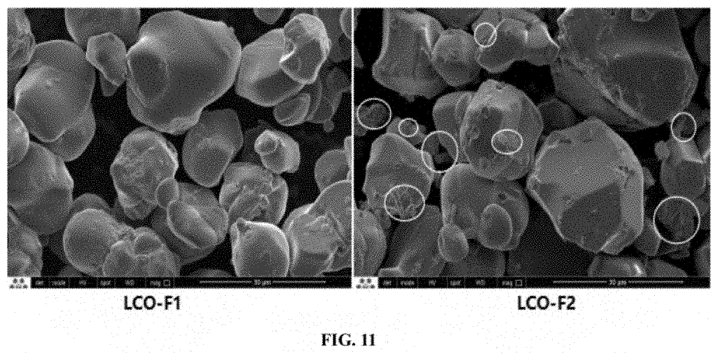

The morphologies of LCO-F1 and LCO-F2 are shown in FIG. 11, and it can be seen from FIG. 11 that, in the cathode composite material of Example 5, phosphate is uniformly distributed and coated on the surface of the cathode material, but in the composite prepared by the conventional method, phosphate is mostly attached to the surface of the cathode material in an agglomerated state (the structure circled in FIG. 11 indicates the agglomerated cobalt phosphate).

What is claimed is:

1. A cathode composite material for a lithium-ion battery (LIB), comprising a lithium-containing matrix and a three-layer coating layer coated on a surface of the matrix, wherein the three-layer coating layer comprises an inner lithium-deficient matrix material layer, an intermediate lithium-deficient lithium cobalt phosphate (LCP) layer, and an outer cobalt phosphate layer.

2. The cathode composite material of claim 1, wherein the lithium-containing matrix is a layered lithium composite oxide, with a chemical formula of LiₐCo_{1-b} M_{b}O₂, wherein M is one or more selected from the group consisting of Mg, Al, M, Zr, and W, 0.95≤a≤1.1, and 0.0≤b≤0.01.

3. The cathode composite material of claim 1, wherein the lithium-deficient matrix material layer has a chemical formula of Li_{c}Co_{1-b}M_{b}O₂, wherein M is one or more selected from the group consisting of Mg, Al, M, Zr, and W, 0.0<c<1.0, a<c, and 0.0≤b≤0.01.

4. The cathode composite material of claim 1, wherein the lithium-deficient LCP layer has a chemical formula of Li_{d}CoPO₄, wherein 0.0<d<1.0.

5. The cathode composite material of claim 1, wherein the cobalt phosphate layer has a chemical formula of Coₘ(PO₄)ₙ, wherein m/n=1.3 to 1.7.

6. The cathode composite material of claim 1, wherein the lithium-deficient LCP layer has a thickness of no more than 10 nm, and the cobalt phosphate layer has a thickness of no more than 10 nm.

7. The cathode composite material of claim 1, wherein the D50 particle size is from 6 μm to 23 μm.

8. A preparation method of the cathode composite material of claim 1, comprising the following steps:
(1) mixing a cathode material precursor and a lithium source, and subjecting a resulting mixture to a heat treatment for 6 h to 20 h to obtain the lithium-containing matrix; and
(2) mixing cobalt phosphate and the lithium-containing matrix, and subjecting a resulting mixture to a heat treatment for 3 h to 9 h to obtain the cathode composite material, wherein a mass ratio of the cobalt phosphate to the cathode material matrix is (0.005:1) to (0.5:1).

9. The preparation method of claim 8, wherein in step (2), when the mass ratio of the cobalt phosphate to the cathode material matrix is (0.005:1) to (0.02:1), the heat treatment is conducted at 400° C. to 600° C. for 3 h to 6 h.

10. The preparation method of claim 8, wherein in step (2), when the mass ratio of the cobalt phosphate to the cathode material matrix is (0.02:1) to (0.04:1), the heat treatment is conducted at 600° C. to 800° C. for 5 h to 9 h.

11. The preparation method of claim 8, wherein in step (2), when the mass ratio of the cobalt phosphate to the cathode material matrix is (0.04:1) to (0.05:1), the heat treatment is conducted at 800° C. to 900° C. for 7 h to 9 h.

12. The preparation method of claim 8, wherein the cobalt phosphate has a particle size of 5 nm to 200 nm.

13. The preparation method of claim 8, wherein the lithium-containing matrix is a layered lithium composite oxide, with a chemical formula of LiₐCo_{1-b}M_{b}O₂, wherein M is one or more selected from the group consisting of Mg, Al, Ti, Zr, and W, 0.95≤a≤1.1, and 0.0≤b≤0.01.

14. The preparation method of claim 8, wherein the lithium-deficient matrix material layer has a chemical formula of Li_{c}Co_{1-b}M_{b}O₂, wherein M is one or more selected from the group consisting of Mg, Al, Ti, Zr, and W, 0.0<c<1.0, a<c, and 0.0≤b≤0.01.

15. The preparation method of claim 8, wherein the lithium-deficient LCP layer has a chemical formula of Li_{d}CoPO₄, wherein 0.0<d<1.0.

16. The preparation method of claim 8, wherein the cobalt phosphate layer has a chemical formula of Coₘ(PO₄)ₙ, wherein m/n=1.3 to 1.7.

17. The preparation method of claim 8, wherein the lithium-deficient LCP layer has a thickness of no more than 10 nm, and the cobalt phosphate layer has a thickness of no more than 10 nm.

18. The preparation method of claim 8, wherein the D50 particle size is from 6 μm to 23 μm.
